(19) United States
(12) Patent Application Publication
(10) Pub. No.: US 2026/0369846 A1
(43) Pub. Date: Nov. 19, 2026

(54) SECONDARY BATTERY

(71) Applicant: SAMSUNG SDI CO., LTD., Yongin-si (KR)

(72) Inventors: Min Hee KIM, Yongin-si (KR); Seung Woo LEE, Yongin-si (KR); Sun A LEE, Yongin-si (KR); Hui Jeong CHO, Yongin-si (KR); Han Woong CHO, Yongin-si (KR)

(21) Appl. No.: 19/298,423

(22) Filed: Aug. 13, 2025

(30) Foreign Application Priority Data
Feb. 19, 2025 (KR) 10-2025-0021358

(51) Int. Cl. H01M 50/595; B60L 50/64; H01M 10/0587; H01M 50/103; H01M 50/15; H01M 50/533; H01M 50/55; H01M 50/557; H01M 50/586

(52) U.S. Cl. CPC H01M 50/595; H01M 10/0587; H01M 50/103; H01M 50/15; H01M 50/533; H01M 50/55; H01M 50/557; H01M 50/586; B60L 50/64; H01M 2220/20

(57) ABSTRACT

A secondary battery may include an electrode assembly formed by stacking and winding a first electrode plate, a separator, and a second electrode plate, the electrode assembly having two round portions which are each symmetrical about a core axis, a case configured to accommodate the electrode assembly, the case having an open end, and a cap plate configured to seal the case. The electrode assembly may include a fixing tape attached to and wrapping around at least one of the two round portions.

### CROSS-REFERENCE TO RELATED APPLICATIONS

The present application claims priority to and the benefit of Korean Patent Application No. 10-2025-0021358, filed on Feb. 19, 2025, in the Korean Intellectual Property Office, the entire disclosure of which is incorporated herein by reference.

### BACKGROUND

### 1. Field

Embodiments of the present disclosure relate to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Some embodiments of the present disclosure provide a secondary battery, in which a round portion that is greatly lifted due to swelling is attached outward from a core so as to be wrapped, thereby preventing resistance, when lifting of the round portion, from increasing to improve a lifespan of the secondary battery.

These and other aspects and features of the present disclosure will be described in or will be apparent from the following description of embodiments of the present disclosure.

According to some embodiments of the present disclosure, a secondary battery may include an electrode assembly formed by stacking and winding a first electrode plate, a separator, and a second electrode plate, the electrode assembly having two round portions which may be each symmetrical about a core axis, a case configured to accommodate the electrode assembly, the case having an open end, and a cap plate configured to seal the case. The electrode assembly may include a fixing tape attached to and wrapping around at least one of the two round portions.

In some embodiments, the case may include a bottom plate, which may be rectangular and four sidewalls, each extending upward from a side of the bottom plate. The four sidewalls may include two long sidewalls, each extending upward each from a long side of the bottom plate and two short sidewalls, each extending upward from a short side of the bottom plate, the two short sidewalls configured to connect the two long sidewalls together.

In some embodiments, the electrode assembly may include two long side portions, each facing an inner surface of one of the two the long sidewalls of the case and two round portions, each facing an inner surface of one of the two short In some embodiments, the fixing tape may include at least one of a first fixing tape attached to an upper side of one of the two round portions of the electrode assembly or a second fixing tape attached to a lower side of one of the two round portions of the electrode assembly.

In some embodiments, the fixing tape may include a first fixing tape attached to an upper side of one round portion of the electrode assembly and a second fixing tape attached to a lower side of the other round portion of the electrode assembly.

In some embodiments, the fixing tape may include a second fixing tape attached to a lower side of one round portion of the electrode assembly and a first fixing tape attached to an upper side of the other round portion of the electrode assembly.

In some embodiments, the electrode assembly may further include a first electrode non-coating portion of the first electrode plate, the first electrode non-coating portion protruding upward and a second electrode non-coating portion of the second electrode plate, the second electrode non-coating portion protruding upward and being spaced apart from the first electrode non-coating portion.

In some embodiments, the secondary battery may further include a first terminal electrically connected to the first electrode non-coating portion and passing through the cap plate such that a portion of the first terminal above the cap plate may be exposed and a second terminal electrically connected to the second electrode non-coating portion and passing through the cap plate such that a portion of the second terminal above the cap plate may be exposed.

In some embodiments, the fixing tape may be attached to at least one of the two round portions so as to be parallel to a second direction, which may be a longitudinal direction of the cap plate.

In some embodiments, two fixing tapes may be attached to one round portion.

In some embodiments, the two fixing tapes may be attached to each of the two round portions symmetrically with respect to a second direction, which may be a longitudinal direction of the cap plate.

In some embodiments, the electrode assembly may include an upper part of each round portion, the upper part of each round portion facing the cap plate, and may include a lower part of each round portion, the lower part of each round portion facing an inner surface of the bottom plate of the case.

In some embodiments, the fixing tape may be attached to an upper part of at least one round portion of the electrode assembly and a lower part of at least one round portion of the electrode assembly.

In some embodiments, the electrode assembly may include a first electrode non-coating portion of the first electrode plate, the first electrode non-coating portion protruding to one side of the electrode assembly in a second direction, which may be a longitudinal direction of the cap plate and a second electrode non-coating portion of the second electrode plate, the second electrode non-coating portion protruding to the other side of the electrode assembly in the second direction.

In some embodiments, the secondary battery may further include a first terminal electrically connected to the first electrode non-coating portion and passing through the cap plate such that a portion of the first terminal above the cap plate may be exposed and a second terminal electrically connected to the second electrode non-coating portion and passing through the cap plate such that a portion of the second terminal above the cap plate may be exposed.

In some embodiments, the secondary battery may further include a first current collector plate configured to electrically connect the first electrode non-coating portion to the first terminal and a second current collector plate configured to electrically connect the second electrode non-coating portion to the second terminal.

In some embodiments, the fixing tape may include at least one of a first fixing tape attached to the upper part of one round portion of the electrode assembly and the lower part of the one round portion of the electrode assembly or a second fixing tape attached to the upper part of the other round portion of the electrode assembly and the lower part of the other round portion of the electrode assembly.

In some embodiments, only one fixing tape may be attached to one round portion.

In some embodiments, the fixing tape may be made of an insulating material having no elasticity and including a film-type tape.

In some embodiments, the fixing tape may be configured to fix together the first electrode plate, the separator, and the second electrode plate, the fixing tape being disposed on a round portion, the fixing tape securing the first electrode plate and the separator in contact with each other and the separator and the second electrode plate in contact with each other.

According to some embodiments, an electrode assembly includes a fixing tape attached to a round portion of the electrode assembly so that resistance due to lifting between an electrode plate and a separator is prevented from increasing and a lifespan of a secondary battery of the electrode assembly is improved.

According to another aspect of the present disclosure, a battery pack manufactured with the battery of this disclosure (a battery having an improved structure by incorporating aspects of this disclosure) may be provided, and a vehicle including the battery may also be provided.

However, the effects obtainable through the present disclosure are not limited to the effects described above, and other technical effects not mentioned will be clearly understood by those skilled in the art from the description of the invention described below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view of a secondary battery according to some embodiments of the present disclosure.

FIG. 2 illustrates a cross-sectional view of the secondary battery of FIG. 1, taken along line A-A′, according to some embodiments of the present disclosure.

FIG. 3 illustrates an exploded perspective view of a case of the secondary battery of FIG. 1 according to some embodiments of the present disclosure.

FIG. 4 illustrates a perspective view of an electrode assembly of the secondary battery of FIG. 2 according to some embodiments of the present disclosure.

FIG. 5 illustrates a fixing tape attached to a round portion of the electrode assembly of FIG. 4 according to some embodiments of the present disclosure.

FIG. 6 illustrates the fixing tape attached to the round portion of the electrode assembly of FIG. 4 according to some embodiments of the present disclosure.

FIG. 7 illustrates a cross-sectional view of the secondary battery of FIG. 1, taken along line A-A′, according to some embodiments of the present disclosure.

FIG. 8 illustrates a perspective view of an electrode assembly of the secondary battery of FIG. 7 according to some embodiments of the present disclosure.

FIGS. 9A and 9B illustrate perspective views of a battery pack including a secondary battery according to some embodiments of the present disclosure.

FIGS. 10A and 10B illustrate perspective and side views of a vehicle including a battery pack according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

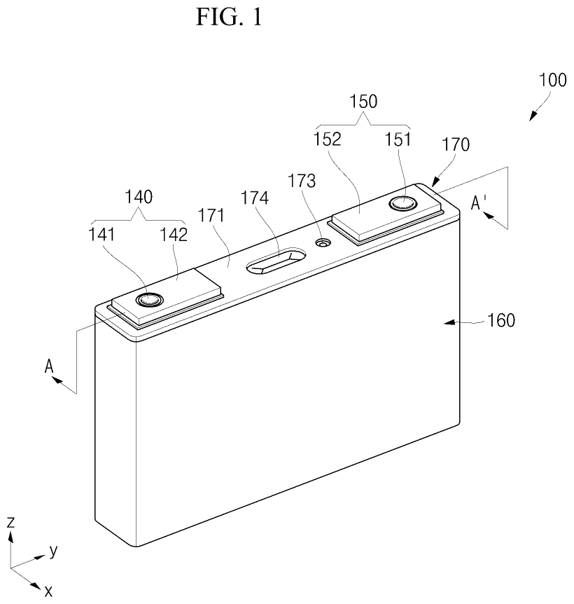

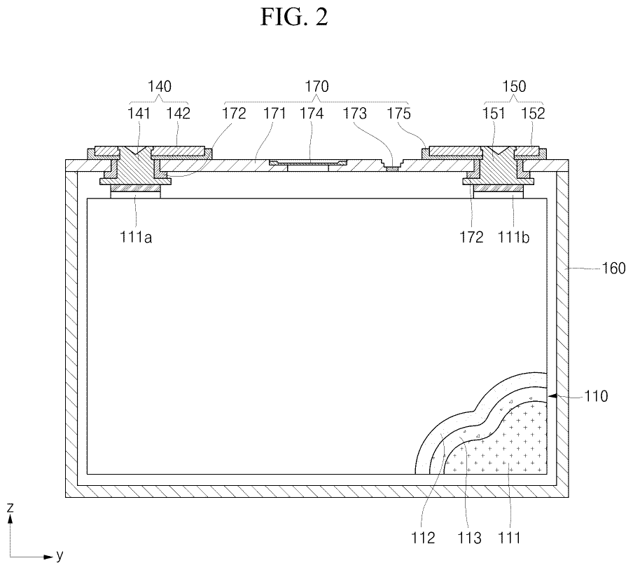

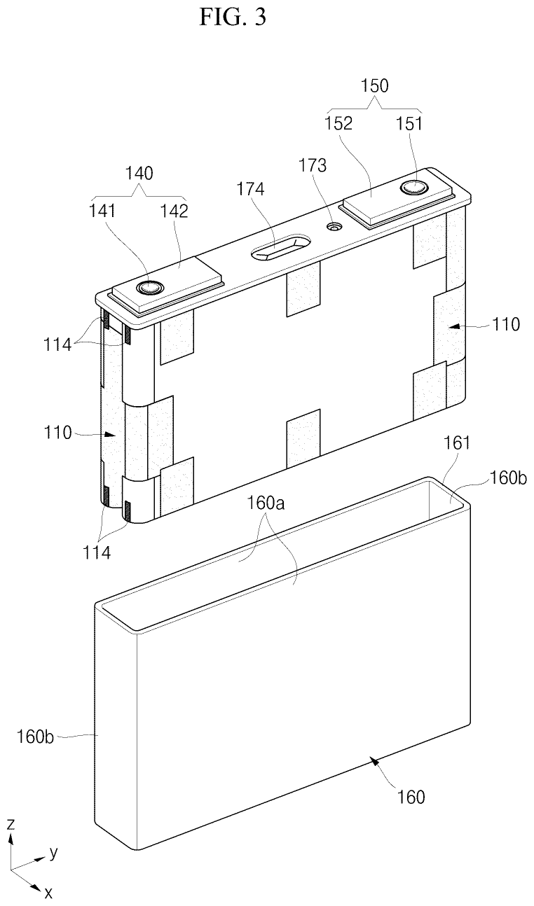

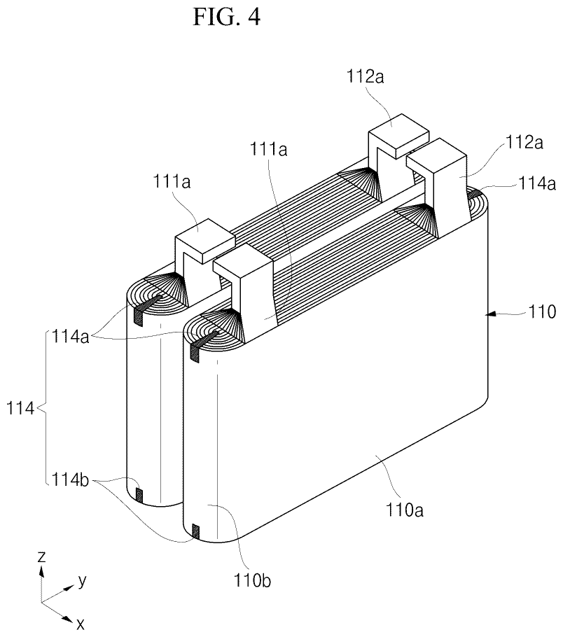

FIG. 1 illustrates a perspective view of a secondary battery according to some embodiments of the present disclosure. FIG. 2 illustrates a cross-sectional view of the secondary battery of FIG. 1, taken along line A-A′, according to some embodiments of the present disclosure. FIG. 3 illustrates an exploded perspective view of a case of the secondary battery of FIG. 1 according to some embodiments of the present disclosure. FIG. 4 illustrates a perspective view of an electrode assembly of the secondary battery of FIG. 2 according to some embodiments of the present disclosure.

The secondary battery 100 according to some embodiments may include an electrode assembly 110, a first terminal 140, a second terminal 150, a case 160, and a cap assembly 170. The secondary battery 100 according to some embodiments may be a prismatic secondary cell or battery.

The electrode assembly 110 may have a jelly-roll shape, in which a first electrode plate 111, a separator 113, and a second electrode plate 112, each of which have a thin plate or film shape, are stacked and then wound. The first electrode plate 111 may operate as first polarity (for example, a positive electrode), and the second electrode plate 112 may operate as second polarity (for example, a negative electrode). In some embodiments, in the electrode assembly 110, a core axis may be defined along a third direction z that is a vertical direction.

The first electrode plate 111 may be provided by applying a first electrode active material such as a transition metal oxide on a first electrode current collector made of metal foil such as aluminum foil, and the first electrode plate 111 may include a first electrode non-coating portion 111a on which the first electrode active metal is not applied. The first electrode non-coating portion 111a may provide a passage through which current flows between the first electrode plate 111 and the outside. The first electrode non-coating portion 111a may protrude to an upper side of the electrode assembly 110. In some embodiments, a plurality of first electrode non-coating portions may be welded to each other to provide one first current collection tab. The plurality of first electrode non-coating portions 111a may overlap each other in the first direction x, which is a thickness direction of the electrode assembly 110. Each of the first electrode non-coating portions 111a may protrude to the upper side of the electrode assembly 110, at which the cap assembly 170 is disposed.

The second electrode plate 112 may be formed by applying a second electrode active material such as graphite or carbon on a first electrode current collector made of metal foil such as nickel foil or copper foil, and the second electrode plate 112 may include a second electrode non-coating portion 112a on which the second electrode active metal is not applied. In some embodiments, the second electrode non-coating portion may protrude to the upper side of the electrode assembly 110. In some embodiments, a plurality of second electrode non-coating portions may be welded to each other to provide one second current collection tab. The plurality of second electrode non-coating portions 112a may overlap each other in the first direction x. The second electrode non-coating portion 112a may be spaced apart from the first electrode non-coating portion 111a in a second direction y, which is a longitudinal direction of the cap plate 171, at the upper side of the electrode assembly.

The electrode assembly 110 may include a first electrode non-coating portion 111a and a second electrode non-coating portion 111b, which protrude upward, and the first electrode non-coating portion 111a and the second electrode non-coating portion 111b may be spaced apart from each other in the second direction y.

The separator 113 may be disposed between the first electrode plate and the second electrode plate to prevent a short circuit from occurring and to enable a movement of lithium ions. The separator 113 may be made of polyethylene, polypropylene, or combination film of polyethylene and polypropylene; however, the present disclosure is not limited thereto.

In the electrode assembly 110, the plurality of electrode plates (the first electrode plate and the second electrode plate) may be stacked or wound together, and a resultant shape of the plurality of electrode plates, when stacked or wound together, may be maintained through a separate insulating tape attached to a partial area of an outer surface. Thereafter, the insulating tape may allow the electrode non-coating portions 111a and 112a of the electrode assembly 110 to be welded to the terminals 140 and 150 at precise positions, respectively, and, also, a structure of the electrode assembly 110 may be fixed in the secondary battery 100.

The electrode assembly 110 may include two long side portions each having a flat area defined by the outermost layer of the electrode assembly after being wound, and two round portions 110b connecting the two long side portions 110a to each other. The two long side portions 110a may be disposed symmetrically around the core axis, and the two round portions 110b may also be disposed symmetrically around the core axis.

The electrode assembly 110 may further include an upper side and a lower side, and the upper side and the lower side may be surfaces through which the electrode plates 111 and 112 and the separator 113 are exposed.

The round portion 110b may have a semicircular shape for a plane of a bottom surface of the round portion 110b. The electrode assembly 110 may further include a fixing tape 114 attached to at least one of the upper side or lower side of each of the two round portions 110b. If the fixing tape 114 is attached to the upper side of both of the two round portions 110b, the fixing tape 114 may be attached to extend from the core through a top surface to an upper outer surface of each of the two round portions 110b. In some embodiments, the fixing tape 114 may be attached to the lower side of each of the two round portions 110b.

The electrode assembly 110 may be accommodated in the case 160 together with the electrolyte. The electrolyte may include an organic solvent, such as ethylene carbonate (EC), propylene carbonate (PC), diethyl carbonate (DEC), ethyl methyl carbonate (EMC), or dimethyl carbonate (DMC), and a lithium salt, such as LiPF₆ or LiBF₄. The electrolyte may be liquid, solid, or gel.

Although two electrode assemblies 110 are shown in the case 160 in FIGS. 2 and 3, the number of electrode assemblies 110 accommodated in the case 160 may be one or more than two. If two electrode assemblies 110 are accommodated in a case 160, the two electrode assemblies 110 may be accommodated in the case 160 so that an outer surface of the long side portion 110a of one electrode assembly 110 faces a long side portion 110a of the other electrode assembly 110.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0<b≤0.5, 0<c<0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The first terminal 140 may be made of a conductive material such as aluminum and may be electrically connected to the first electrode non-coating portion 111a. The first terminal 140 may include a first terminal pillar 141 and a first terminal plate 142.

The first terminal pillar 141 may protrude and may extend upward by a certain length through a cap plate 171 of the cap assembly 170 and may be electrically connected to the first electrode non-coating portion 111a at a lower portion of the cap plate 171. In some embodiments, the first terminal pillar 141 may protrude and extend by a certain length to an upper side of the cap plate 171. A lower portion of the first terminal pillar 141 may be welded to the first electrode non-coating portion 111a.

The first terminal plate 142 may have a hole, and an upper portion of the first terminal pillar 141 may be coupled to the hole and then riveted and/or welded. The first terminal plate 142 may be disposed on an upper portion of the cap plate 171. The first terminal pillar 141 and the first terminal plate 142, which are exposed upward from the cap plate 171, may be welded to each other at an interface. A laser beam may be provided to a boundary area between the first terminal pillar 141 and the first terminal plate 142, which are exposed upward from the cap plate 171, and, thus, the boundary area may be mutually melted and then cooled for welding. In some embodiments, the first terminal pillar 141 and the first terminal plate 142 may be electrically insulated from the cap plate 171.

The second terminal 150 may be made of a conductive material such as nickel and may be electrically connected to the second electrode non-coating portion 112a. The second terminal 150 may include a second terminal pillar 151 and a second terminal plate 152. Because a shape of the second terminal 150 is the same as that of the first terminal 140, duplicate descriptions will be omitted for brevity.

The case 160 may be made of a conductive metal such as aluminum, an aluminum alloy, or nickel-plated steel and may have an approximately hexahedral shape with an opening 161 into which the electrode assembly 110 is inserted and seated. The cap plate 171 may be coupled to the opening 161 of the case 160 to seal the case 160. An inner surface of the case 160 may be insulated to prevent an electrical short circuit from occurring in the case 160.

The case 160 may include a rectangular bottom plate and four sidewalls respectively extending upward from sides of the bottom plate. The sidewalls of the case 160 may include two long sidewalls 160a each respectively facing a long side portion 110a of the electrode assembly 110 and may include two short sidewalls 160b connecting the two long sidewalls 160a to each other. The two long sidewalls 160a may extend upward from long sides of the bottom plate, and the two short sidewalls 160b may extend upward from short sides of the bottom plate. The two short sidewalls 160b may each face a round portion 110b of the electrode assembly.

The cap assembly 170 may be coupled to the opening of the case 160. The cap assembly 170 may include a cap plate 171, a seal gasket 172, a plug 173, a safety vent 174, and a coupler 175.

The cap plate 171 may seal the opening 161 of the case 160. The seal gasket 172 made of an insulating material may be provided between the cap plate 171 and the first terminal pillar 141 of the first terminal 140, and between the cap plate 171 and the second terminal pillar 151 of the second terminal 150. The seal gasket 172 may seal a gap between the first terminal pillar 141 the cap plate 171 and between the second terminal pillar 151 and the cap plate 171. The seal gasket 172 may prevent an ingress of moisture into the secondary battery 100 or leakage of the electrolyte from the secondary battery 100.

The plug 173 may seal an electrolyte injection hole 151a of the cap plate 171, and the safety vent 174 may be installed in the vent hole 151b of the cap plate 171 and may be provided with a notch 154a so as to be opened at a set pressure.

The coupler 175 may be provided between each of the first terminal plate 142 and the second terminal plate 152 and the cap plate 171 at the upper portion of the cap plate 171. In some embodiments, the coupler 175 may be in contact with the cap plate 171. Further, the coupler 175 may be in contact with the seal gasket 172. The coupler 175 may insulate the first terminal plate 142 and the cap plate 171 from each other and may insulate the second terminal plate 152 and the cap plate 171 from each other. In some embodiments, the coupler 175 provided on the first terminal pillar 141 may be electrically connected between the first terminal plate 142 and the cap plate 171, and, thus, the cap plate 171 may have a same polarity as the first terminal 140. The case 160 may also have a same polarity as the cap plate 171, and, in such a case, The interior of the case 160 may be subjected to insulation treatment to prevent an electrical short circuit with the electrode assembly 110.

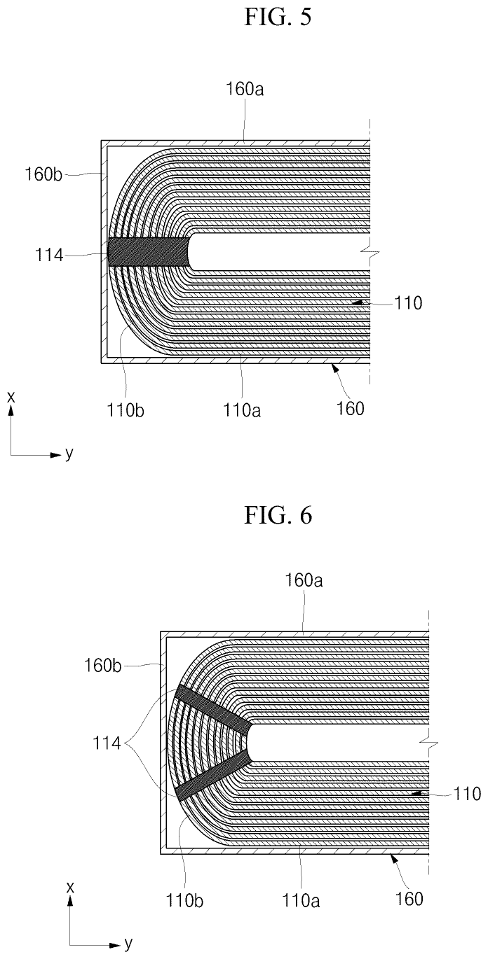

FIG. 5 illustrates a fixing tape attached to a round portion of the electrode assembly of FIG. 4 according to some embodiments of the present disclosure. As illustrated in FIG. 5, an outer surface of the long side portion 110a of the electrode assembly 110 and an inner surface of the long sidewall 160a of the case 160 are adjacent to each other, but there is a large spatial clearance between an outer surface of the round portion 110b of the electrode assembly 110 and an inner surface of the short sidewall 160b. The round portion 110b of the electrode assembly 110 has an approximately semicircular shape in planar shape. However, the short sidewalls 160b and the long sidewalls 160a may be flat, and a spatial clearance may exist between an edge portion, at which the two walls are in contact with each other, and the round portion 110b of the electrode assembly 110 due to a difference between a shape of the round portion 110b and a shape of a short sidewall 160b joined with a long sidewall 160a at an angle.

If swelling occurs due to repeated charging and discharging of the electrode assembly 110, while there may not be a deformation of the long side portion 110a (the long side portion 110a being restricted by the long sidewall 160a of the case 160), without applying aspects of the present disclosure, the round portion 110b may otherwise present a problem where a gap between each of the electrode plates 111 and 112 and the separator 113 is widened to increase in interfacial resistance at the round portion 110b.

The fixing tape 114 may wrap around the core and the outer surface of the round portion 110b of the electrode assembly 110 to prevent the gap of the round portion 110b from being widened. The fixing tape 114 may be fixed so that each of the electrode plates 111 and 112 are each in close contact with the separator 113 to prevent the gap between the electrode plates 111 and 112 and the separator 113 from being widened due to the deformation caused by the swelling. The fixing tape 114 may be attached to the round portion 110b such that it extends along a second direction y, which is a longitudinal direction of the cap plate 171 of the electrode assembly 110. The fixing tape 114 may be attached to the round portion 110b so as to be parallel to the second direction y. In some embodiments, the fixing tape 114 may be a film-type tape having an adhesive layer on one surface thereof.

The fixing tape 114 may fix the round portion 110b that is significantly deformed by the swelling in the electrode assembly 110 to prevent the interface resistance due to the deformation from increasing. The fixing tape 114 may include an area attached to the outer surface of the round portion 110b, an area attached to the upper or lower side of the electrode assembly 110, and an area attached to the core. The fixing tape 114 may be made of an insulating material having no elasticity.

The fixing tape 114 may be attached to at least one of the upper side or lower side of both the round portions 110b of the electrode assembly 110. If the fixing tape 114 is attached to both the upper side and lower sides of both the round portions 110b, the fixing tape 114 may be more effective in preventing the deformation in shape of the round portions 110b, as opposed to when the fixing tape 114 attached to only one of the upper side and lower side.

The fixing tape 114 may include a first fixing tape 114a attached to the upper side of both the round portions 110b, and a second fixing tape 114b attached to the lower side of both the round portions 110b. In some embodiments, the fixing tape 114 may include only the first fixing tape 114a. In some embodiments, the fixing tape 114 may include only the second fixing tape 114b. In some embodiments, the fixing tape 114 may include a first fixing tape 114a attached to the upper side of one round portion 110b and a second fixing tape 114b attached to the lower side of the other round portion 110b. In some embodiments, the fixing tape 114 may include a second fixing tape 114b attached to the lower side of the one round portion 110b and a first fixing tape 114a attached to the upper side of the other round portion 110b.

As described above, the electrode assembly 110 to which the fixing tape 114 is attached may prevent lifting between the electrode plates 111 and 112 and the separator 113 in the round portion 110b, preventing resistance due to the deformation from increasing and thereby improving a lifespan of the secondary battery 100.

FIG. 6 illustrates the fixing tape attached to the round portion of the electrode assembly of FIG. 4 according to some embodiments of the present disclosure.

Two fixing tapes 114 may be attached to the upper side or lower side of one round portion 110b. If the fixing tape 114 is attached to the upper side of both the round portions 110b, the two fixing tapes 114 may be attached symmetrically to each other with an axis splitting the electrode assembly 110 in the second direction y to be a symmetric center of the round portion 110b for the two fixing tapes 114. In some embodiments, if the fixing tape 114 is attached to the upper side of the round portion 110b, the two fixing tapes 114 may be attached to each other so as to have an acute angle with respect to the second direction y in the round portion 110b.

The fixing tape 114 may be attached to at least one of the upper side or the lower side of each of the two round portions 110b. In some embodiments, the fixing tape 114 may be attached to both the upper and lower sides of both of the round portions 110b.

In some embodiments, two fixing tapes 114 may be attached to the upper side or the lower side of one round portion 110b, but more fixing tapes 114 may be attached in other embodiments. However, if the fixing tape 114 is attached to cover the entire round portion 110b, it may not be easy for the electrolyte to be impregnated into the round portion 110b of the electrode assembly 110.

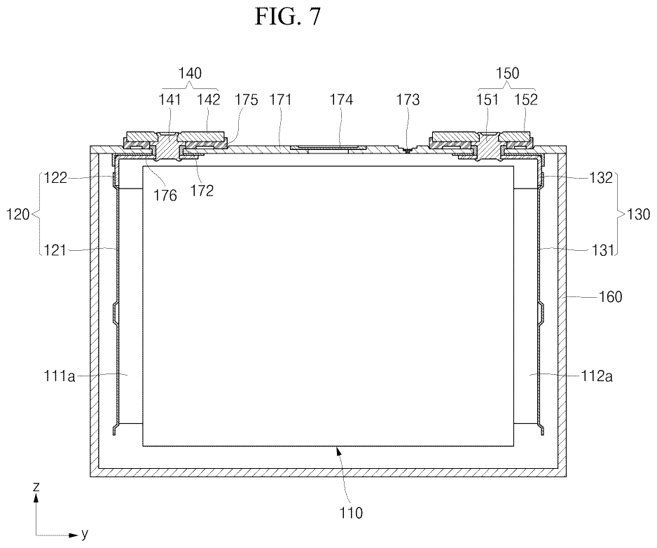

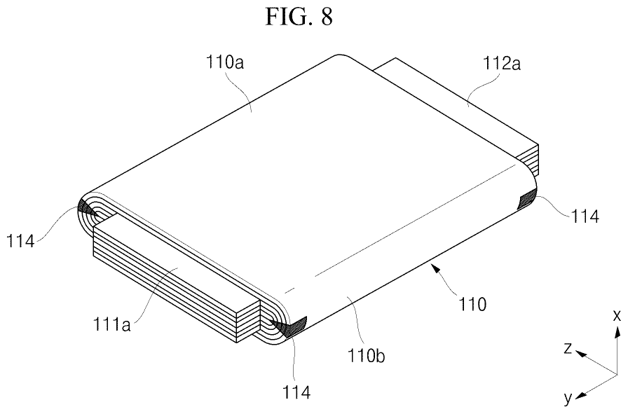

FIG. 7 illustrates a cross-sectional view of the secondary battery of FIG. 1, taken along line A-A′, according to some embodiments of the present disclosure. FIG. 8 illustrates a perspective view of an electrode assembly of the secondary battery of FIG. 7 according to some embodiments of the present disclosure.

The secondary battery 100 illustrated in FIG. 7 according to some embodiments may include an electrode assembly 110, a first current collector plate 120, a second collector plate 130, a first terminal 140, a second terminal 150, a case 160, and a cap assembly 170. In some embodiments, the first terminal 140, the second terminal 150, the case 160, and the cap assembly 170 may be similar to those in the structure of the secondary battery 100 illustrated in FIGS. 2 and 3. However, there may be a difference in that the first terminal 140 and the second terminal 150 may be electrically connected to the electrode assembly 110 through the first current collector plate 120 and the second collector plate 130, respectively.

The electrode assembly 110 may have a jelly-roll shape, in which a first electrode plate 111, a separator 113, and a second electrode plate 112 (each of which is provided in a thin plate or film shape) are stacked and then wound. The first electrode plate 111 may have a first polarity (for example, operating as a positive electrode), and the second electrode plate 112 may have a second polarity (for example, operating as a negative electrode). In some embodiments, the electrode assembly 110 may have a core axis defined along the second direction y, which is an extension direction of the cap plate 171.

The first electrode plate 111 may be provided by applying a first electrode active material such as a transition metal oxide on a first electrode current collector made of metal foil such as aluminum foil, and may include a first electrode non-coating portion 111a on which the first electrode active metal is not applied. The first electrode non-coating portion 111a may protrude to one side of the electrode assembly 110 in the second direction y. In some embodiments, a plurality of first electrode non-coating portions 111a may be welded together to provide one first current collector tab. The plurality of first electrode non-coating portions 111a may overlap each other in the first direction x, which is a thickness direction of the electrode assembly 110.

The second electrode plate 112 may be formed by applying a second electrode active material such as graphite or carbon on a first electrode current collector made of metal foil such as nickel foil or copper foil, and the second electrode plate 112 may include a second electrode non-coating portion 112a on which the second electrode active metal is not applied. In some embodiments, the second electrode non-coating portion 112a may protrude to the other side in the second direction y. The second electrode non-coating portion 112a may protrude from the electrode assembly 110 to an opposite side to the side to which the first electrode non-coating portion 111a protrudes. The first electrode non-coating portion 111a may protrude to one side and the second electrode non-coating portion 112a may protrude another side in the second direction y with respect to the electrode assembly 110. In some embodiments, a plurality of second electrode non-coating portions 112a may be welded together to provide one second collector tab. The plurality of second electrode non-coating portions 112a may overlap each other in the first direction x.

The electrode assembly 110 may include two long side portions each having a flat area defined by an outermost layer of the electrode assembly after being wound, and two round portions 110b connecting the two long side portions 110a to each other. In some embodiments, the round portions 110b may be disposed at the upper and lower sides of the electrode assembly 110, respectively. Each of the round portions 110b may have a semicircular shape.

The electrode assembly 110 may further include a fixing tape 114 attached to the round portion 110b. The fixing tape 114 may be attached to at least one of two upper sides of the round portion 110b and at least one of two lower sides of the round portion 110b. If the fixing tape 114 is attached to an upper part of the round portion 110b and a lower part of the round portion 110b, which are disposed at one side of the electrode assembly 110, the fixing tape 114 may be attached to extend from an upper outer surface of the round portion 110b to a lower outer surface of the round portion 110b via one surface from the core. In some embodiments, the fixing tape 114 may be attached to an outer side surface of each of the upper part of the round portion 110b and the lower part of the round portion 110b. In some embodiments, the fixing tape 114 may be attached to both the inner side and the outer side of the upper part of the round portion 110b and both the inner side and the outer side of the lower part of the round portion 110b.

The fixing tape 114 being attached to both the sides of the upper part of the round portion 110b and both the sides of the lower part of the round portion 110b may be more effective in preventing deformation of a shape of the round portion 110b rather than if the fixing tape is attached to only one side of the upper part of the round portion 110b and only one side of the lower part of the round portion 110b.

The fixing tape 114 may include a first fixing tape attached to one side of the upper part of the round portion 110b and one side of the lower part of the round portion 110b, and a second fixing tape attached to the other side of the upper part of the round portion 110b and the other side of the lower part of the round portion 110b. In some embodiments, the fixing tape 114 may include only the first fixing tape. In some embodiments, the fixing tape 114 may include only the second fixing tape. In some embodiments, the fixing tape 114 may include a first fixing tape attached to one side of the upper part of the round portion 110b and a second fixing tape attached to the other side of the lower part of the round portion 110b. In some embodiments, the fixing tape 114 may include a first fixing tape attached to one side of the lower part of the round portion 110b and a second fixing tape attached to the other side of the upper part of the round portion 110b.

The fixing tape 114 may wrap around the core and the outer surface of the round portion 110b of the electrode assembly 110 to prevent the gap of the round portion 110b from being widened. The fixing tape 114 may fix the electrode plates 111 and 112 and the separator 113, which are disposed on the round portion 110b so that the electrode plates 111 and 112 are in close contact with the separator 113 to prevent the gap between the electrode plates 111 and 112 and the separator 113 from being widened due to the deformation caused by the swelling. The fixing tape 114 may be attached to the round portion 110b to extend along a third direction z, which is a height direction of the case 160. The fixing tape 114 may be attached to the round portion 110b so as to be parallel to the third direction z. In some embodiments, the fixing tape 114 may be a film-type tape having an adhesive layer on one surface thereof.

The fixing tape 114 may fix the round portion 110b that is significantly deformed by the swelling in the electrode assembly 110 to prevent the interface resistance due to the deformation from increasing. The fixing tape 114 may include an area attached to an outer surface of the round portion 110b, an area attached to one side or the other side of the electrode assembly 110, and an area attached to the core. The fixing tape 114 may be made of an insulating material having no elasticity.

As described above, the electrode assembly 110 to which the fixing tape 114 is attached may prevent lifting between the electrode plates 111 and 112 and the separator 113 in the round portion 110b, preventing resistance due to the deformation from increasing and thereby improving a lifespan of the secondary battery 100.

The first current collector plate 120 may be made of a conductive material such as aluminum and may be coupled to the first electrode non-coating portion 111a protruding to one end of the electrode assembly 110 and, thus, may be electrically connected to the first electrode plate. The first current collector plate 120 may be electrically connected to the first electrode non-coating portion 111a by welding. The first current collector plate 120 may include a first electrode connection part 121 extending vertically along one side of the electrode assembly 110 and a first terminal connection part 122 interposed between the electrode assembly 110 and the cap assembly 170 and coupled to the first terminal 140.

The first electrode connection part 121 may extend vertically along one side of the electrode assembly 110 and may have an approximately plate shape. The first electrode connection part 121 may be coupled by welding to the first electrode non-coating portion 111a of the electrode assembly 110 and thus may have the same first polarity as the first electrode non-coating portion 111a. For convenience of explanation below, a surface of the first electrode connection part 121, which faces one surface of the electrode assembly 110, may be referred to as an inner surface, and a surface facing a surface of the case 160 may be referred to as an outer surface.

The first terminal connection part 122 may be bent from an upper end of the first electrode connection part 121 and may be interposed between the cap assembly 170 and the electrode assembly 110. The first terminal connection part 122 may be integrated with the first electrode connection part 121 or may be welded and coupled to the upper end of the first electrode connection part 121 through welding.

The second collector plate 130 may be made of a conductive material such as nickel or copper and may be in contact with the second electrode non-coating portion 112a protruding from the other end of the electrode assembly 110 and, thus, may be electrically connected to the second electrode plate 112. The second collector plate 130 may include a second electrode connection part 131 and a second terminal connection part 132. Because a shape of the second collector plate 130 is the same as that of the first current collector plate 120, duplicated descriptions will be omitted.

In some embodiments, the secondary battery 100 may further include a lower insulator 176 interposed between the first current collector plate 120 and the cap plate 171 and between the second collector plate 130 and the cap plate 171. The lower insulator 176 may prevent electrical connection between the cap plate 171 and the first current collector plate 120 and may prevent electrical connection between the second collector plate 130 and the cap plate 171.

The secondary battery according to the above-described embodiment can be used to manufacture a battery pack.

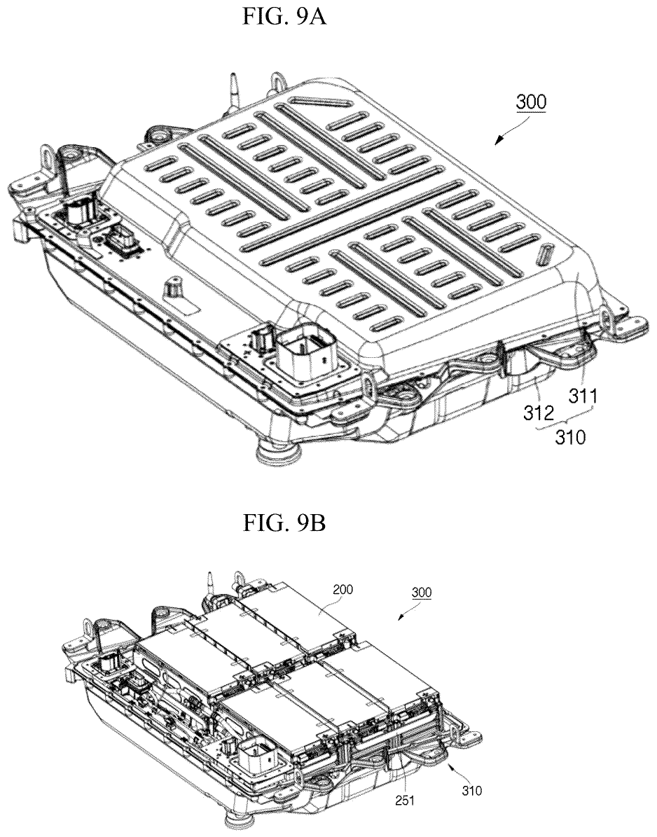

FIGS. 9A and 9B illustrate perspective views of a battery pack including a secondary battery according to some embodiments of the present disclosure. The battery pack 300 may include a plurality of battery modules 200 and a housing 310 configured to accommodate the plurality of battery modules 200. For example, the housing 310 may include a first housing and a second housing, which are coupled to each other in directions facing each other with the plurality of battery modules 200 interposed therebetween. The plurality of battery modules 200 may be electrically connected to each other using bus bars 251. The plurality of battery modules 200 may be electrically connected to each other in series, in parallel, or in a combination thereof, so that desired electrical output may be obtained.

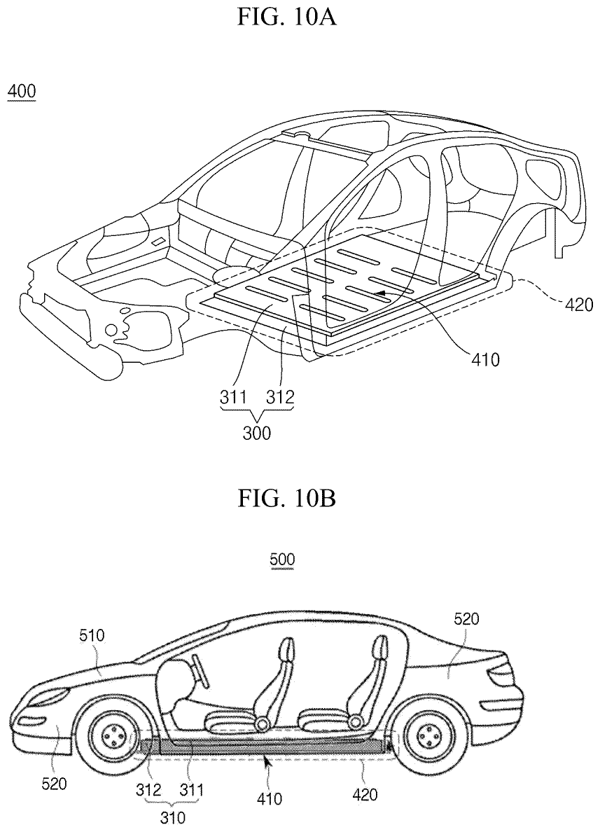

FIGS. 10A and 10B illustrate perspective and side views of a vehicle including a battery pack according to some embodiments of the present disclosure. As shown in FIG. 10A, the battery pack 300 may include a battery pack cover 311 (which may correspond to the first housing), which is a portion of a vehicle underbody 410, and a pack frame 312 (which may correspond to the second housing), which is disposed beneath the vehicle underbody 410. The battery pack cover 311 and the pack frame 312 may be integrally formed with a vehicle bottom portion 420. The vehicle underbody 410 may separate the interior and the exterior of the vehicle from each other, and the pack frame 312 may be disposed outside the vehicle.

As shown in FIG. 10B, the vehicle 500 may include a vehicle body 400 and various parts coupled to the vehicle body 400, such as a hood 510 located at the front portion of the vehicle and fenders 520 located at the front and rear portions of the vehicle. The vehicle 500 may include the battery pack 300 including the battery pack cover 311 and the pack frame 312, and the battery pack 300 may be coupled to the vehicle body 400.

The above shows only some embodiments for implementing a secondary battery according to the present disclosure, but the present disclosure is not limited to the above embodiments. There is a technical spirit of the disclosure to the extent that various modifications can be made by anyone having ordinary skill in the art to which the present disclosure pertains without departing from embodiments of the present disclosure.

What is claimed is

1. A secondary battery comprising:
an electrode assembly formed by stacking and winding a first electrode plate, a separator, and a second electrode plate, the electrode assembly having two round portions that are each symmetrical about a core axis;
a case configured to accommodate the electrode assembly, the case having an open end; and
a cap plate configured to seal the case,
wherein the electrode assembly includes a fixing tape attached to and wrapping around at least one of the two round portions, and
wherein the fixing tape is disposed to wrap around at least one of the two round portions of the electrode assembly from the core toward the outer surface.

2. The secondary battery as claimed in claim 1, wherein the case includes:
a bottom plate, which is rectangular; and
four sidewalls, each extending upward from a side of the bottom plate,
wherein the four sidewalls include:
two long sidewalls, each extending upward each from a long side of the bottom plate; and
two short sidewalls, each extending upward from a short side of the bottom plate, the two short sidewalls configured to connect the two long sidewalls together.

3. The secondary battery as claimed in claim 2, wherein the electrode assembly includes:
two long side portions, each facing an inner surface of one of the two the long sidewalls of the case; and
two round portions, each facing an inner surface of one of the two short sidewalls of the case.

4. The secondary battery as claimed in claim 3, wherein the fixing tape includes at least one of:
a first fixing tape attached to an upper side of one of the two round portions of the electrode assembly; or
a second fixing tape attached to a lower side of one of the two round portions of the electrode assembly.

5. The secondary battery as claimed in claim 3, wherein the fixing tape includes:
a first fixing tape attached to an upper side of one round portion of the electrode assembly; and
a second fixing tape attached to a lower side of the other round portion of the electrode assembly.

6. The secondary battery as claimed in claim 3, wherein the fixing tape includes:
a second fixing tape attached to a lower side of one round portion of the electrode assembly; and
a first fixing tape attached to an upper side of the other round portion of the electrode assembly.

7. The secondary battery as claimed in claim 1, wherein the electrode assembly further includes:
a first electrode non-coating portion of the first electrode plate, the first electrode non-coating portion protruding upward; and
a second electrode non-coating portion of the second electrode plate, the second electrode non-coating portion protruding upward and being spaced apart from the first electrode non-coating portion.

8. The secondary battery as claimed in claim 7, further comprising:
a first terminal electrically connected to the first electrode non-coating portion and passing through the cap plate such that a portion of the first terminal above the cap plate is exposed; and
a second terminal electrically connected to the second electrode non-coating portion and passing through the cap plate such that a portion of the second terminal above the cap plate is exposed.

9. The secondary battery as claimed in claim 3, wherein the fixing tape is attached to at least one of the two round portions so as to be parallel to a second direction, which is a longitudinal direction of the cap plate.

10. The secondary battery as claimed in claim 3, wherein two fixing tapes are attached to one round portion.

11. The secondary battery as claimed in claim 10, wherein the two fixing tapes are attached to each of the two round portions symmetrically with respect to a second direction, which is a longitudinal direction of the cap plate.

12. The secondary battery as claimed in claim 2, wherein the electrode assembly includes an upper part of each round portion, the upper part of each round portion facing the cap plate, and includes a lower part of each round portion, the lower part of each round portion facing an inner surface of the bottom plate of the case.

13. The secondary battery as claimed in claim 12, wherein the fixing tape is attached to an upper part of at least one round portion of the electrode assembly and a lower part of at least one round portion of the electrode assembly.

14. The secondary battery as claimed in claim 12, wherein the electrode assembly includes:
a first electrode non-coating portion of the first electrode plate, the first electrode non-coating portion protruding to one side of the electrode assembly in a second direction, which is a longitudinal direction of the cap plate; and
a second electrode non-coating portion of the second electrode plate, the second electrode non-coating portion protruding to the other side of the electrode assembly in the second direction.

15. The secondary battery as claimed in claim 14, further comprising:
a first terminal electrically connected to the first electrode non-coating portion and passing through the cap plate such that a portion of the first terminal above the cap plate is exposed; and
a second terminal electrically connected to the second electrode non-coating portion and passing through the cap plate such that a portion of the second terminal above the cap plate is exposed.

16. The secondary battery as claimed in claim 15, further comprising:
a first current collector plate configured to electrically connect the first electrode non-coating portion to the first terminal; and
a second current collector plate configured to electrically connect the second electrode non-coating portion to the second terminal.

17. The secondary battery as claimed in claim 13, wherein the fixing tape includes at least one of:
a first fixing tape attached to the upper part of one round portion of the electrode assembly and the lower part of the one round portion of the electrode assembly; or
a second fixing tape attached to the upper part of the other round portion of the electrode assembly and the lower part of the other round portion of the electrode assembly.

18. The secondary battery as claimed in claim 9, wherein only one fixing tape is attached to one round portion.

19. The secondary battery as claimed in claim 1, wherein the fixing tape is made of an insulating material having no elasticity and including a film-type tape.

20. The secondary battery as claimed in claim 1, wherein the fixing tape is configured to fix together the first electrode plate, the separator, and the second electrode plate, the fixing tape being disposed on a round portion, the fixing tape securing the first electrode plate and the separator in contact with each other and the separator and the second electrode plate in contact with each other.
